(19) United States
(12) Patent Application Publication
(10) Pub. No.: US 2026/0010349 A1
(43) Pub. Date: Jan. 8, 2026

(54) SYSTEM AND METHOD FOR GENERATING INSTRUCTION CODES OF A MICROCONTROLLER UNIT

(71) Applicant: ITDA SEMICONDUCTOR CO., LTD., Hwaseong-si (KR)

(72) Inventors: Ahchan KIM, Hwaseong-si (KR); Hoyeon JEON, Seongnam-si (KR); Ingyu KIM, Hwaseong-si (KR)

(73) Assignee: ITDA SEMICONDUCTOR CO., LTD., Hwaseong-si (KR)

(21) Appl. No.: 19/255,682

(22) Filed: Jun. 30, 2025

(30) Foreign Application Priority Data
Jul. 2, 2024 (KR) 10-2024-0086592
Aug. 7, 2024 (KR) 10-2024-0105469

(51) Int. Cl. G06F 8/34; G06F 8/51

(52) U.S. Cl. CPC G06F 8/34; G06F 8/51

(57) ABSTRACT

The present disclosure relates to a system and method for providing a flowchart-based user interface to a user and generating instruction codes of a microcontroller unit based on an operation process of the microcontroller unit designed by the user. The system for generating the instruction codes of the microcontroller unit according to an embodiment of the present disclosure includes: a memory configured to store at least one instruction; a component storage; a code conversion logic storage; and a processor, wherein the at least one instruction includes instructions for: generating a first flowchart instance based on at least one flowchart component; further receiving a target component and at least one of a property, and a value of the first flowchart instance to generate an operation process; and converting the operation process into an instruction code including an instruction, a register address, and data based on the code conversion logic.

### STATEMENT REGARDING GOVERNMENT SPONSORED RESEARCH OR DEVELOPMENT

This invention was made with support from the Ministry of SMEs and Startups through a grant funded by the Korea Technology and Information Promotion Agency for SMEs (TIPA), under Project Unique Number 1425182152 and Project Number RS-2023-00302523, within the Startup Growth Technology Development (R&D) program. The project titled “Low-Code Based Low-Power Semiconductor Solution” was executed by ITDA Semiconductor Co., Ltd., with the research period spanning from Jul. 1, 2023, to Jun. 30, 2026. However, no rights in the invention are held by the government of the Republic of Korea.

### CROSS-REFERENCE TO RELATED APPLICATION

This application claims the benefit of and priority to Korean Patent Application Nos. 10-2024-0086592, filed on Jul. 2, 2024, and 10-2024-0105469, filed on Aug. 7, 2024, the entire disclosures of which are hereby incorporated herein by reference in their entirety.

### TECHNICAL FIELD

The present disclosure relates to a system and method for generating instruction codes of a microcontroller unit, and more specifically, to a system and method for providing a flowchart-based user interface to a user and generating instruction codes of the microcontroller unit based on an operation process of the microcontroller unit designed by the user.

### BACKGROUND

A microcontroller unit (MCU) is a small computer used in embedded systems, and is a single integrated circuit including a CPU, memory, and input/output ports, and performs a role of controlling various sensors and devices. The instruction code of the microcontroller unit is a program code written in a form that can be understood by the microcontroller unit to perform a specific task.

Generally, in order to write the instruction code of the microcontroller unit, a person (programmer) must directly code using a programming language such as assembly language or C language. This direct coding method requires a lot of time and effort. Since the instruction code of the microcontroller unit is very complex, there is a problem in that the process of directly coding and debugging the code is complex, requires a lot of time, and is highly likely to cause errors.

In addition, since a person who does not have programming knowledge cannot write the instruction code of the microcontroller unit, there is a problem in that a barrier to entry exists in system-on-chip development.

### SUMMARY

The present disclosure has been devised to solve the above-described problem, and is directed to providing a system and method capable of more simply and efficiently generating instruction codes of a microcontroller unit by converting an operation process of the microcontroller unit, which is designed through a flowchart-based user interface, into instruction codes of the microcontroller unit.

The present disclosure may be implemented in various ways, including a device (system), a method, a computer program stored in a computer-readable medium, or a computer-readable medium in which a computer program is stored.

According to an embodiment of the present disclosure, a system for generating instruction codes of a microcontroller unit comprises: a memory configured to store at least one instruction; a component storage configured to store information on at least one flowchart component; a code conversion logic storage configured to store code conversion logic for generating instruction codes based on at least one flowchart instance; and at least one processor configured to execute the at least one instruction stored in the memory. The at least one instruction includes instructions for generating a first flowchart instance based on the at least one flowchart component, generating an operation process by receiving at least one of a target component, a property, or a value of the first flowchart instance, and converting the operation process into an instruction code based on the code conversion logic, the instruction code including at least one assembly instruction, a register address, and data.

Preferably, the at least one instruction may further include instructions for generating a second flowchart instance based on the at least one flowchart component, receiving at least one of a target component, a property, and a value of the second flowchart instance, and setting an execution order between the first flowchart instance and the second flowchart instance.

Preferably, the flowchart component may include at least one of: a write (WRITE) component for writing a specific value to a specific register field; an input wait (READWAIT) component for waiting for a specific value to be input to a specific register field; a wait (WAIT) component for waiting for a predetermined period of time; a condition (IF) component for branching according to a condition; a move (GOTO) component for moving to a specific location; a call (CALL) component for moving to a specific location and allowing a return; a label (LABEL) component; a label reference (LABEL_REF) component; a start (START) component; and an end (END) component.

More preferably, the flowchart component includes a border having a distinctive shape.

More preferably, the label (LABEL) component and the label reference (LABEL_REF) component enable two or more flowchart components, which are spaced apart from each other, to be substantially connected, and at least one of a label name and a color is set for the label component and the label reference component to enable identification.

More preferably, the at least one instruction comprises instructions for determining whether at least one of a target component, a property, and a value of the first flowchart instance and at least one of a target component, a property, and a value of the second flowchart instance conform to an input rule, and for detecting an error.

More preferably, at least one of the flowchart components is matched with at least two assembly instructions, and the at least one instruction comprises instructions for determining one assembly instruction based on at least one of a target component, a property, and a value of the first flowchart instance.

More preferably, the at least one instruction comprises instructions for determining a register address and data of the determined assembly instruction based on at least one of a target component, a property, and a value of the first flowchart instance.

Preferably, the target component comprises at least one of a reset component, an isolation component, a switch control component, a retention component, an automatic power manager component, a reference clock gating component, a memory component, a handshake component, a clock link component, a P-channel handshake component, a user-defined output component, and a user-defined input component.

Preferably, the target component comprises at least one of an information register generation component, a timeout register generation component, an upper-level information transfer register generation component, an internal register storage component, an internal register control interrupt generation component, an external input control interrupt generation component, a timer generation component, and a domain power manager connection component.

According to one embodiment of the present disclosure, a method for generating instruction codes of a microcontroller unit is performed by at least one processor in a computer system including a component storage configured to store information on at least one flowchart component and a code conversion logic storage configured to store code conversion logic for generating instruction codes based on at least one flowchart instance. The method comprises: generating a first flowchart instance based on the at least one flowchart component; generating an operation process by receiving at least one of a target component, a property, and a value of the first flowchart instance; and converting the operation process into an instruction code including an assembly instruction, a register address, and data based on the code conversion logic.

Preferably, the method for generating instruction codes further comprises: generating a second flowchart instance based on the at least one flowchart component; receiving at least one of a target component, a property, and a value of the second flowchart instance; and setting an execution order between the first flowchart instance and the second flowchart instance.

Preferably, the flowchart component includes at least one of: a write (WRITE) component for writing a specific value to a specific register field; an input wait (READWAIT) component for waiting for a specific value to be input to a specific register field; a wait (WAIT) component for waiting for a predetermined period of time; a condition (IF) component for branching according to a condition; a move (GOTO) component for moving to a specific location; a call (CALL) component for moving to a specific location and allowing a return; a label (LABEL) component; a label reference (LABEL_REF) component; a start (START) component; and an end (END) component.

More preferably, the flowchart component includes a border having a distinctive shape.

More preferably, the label (LABEL) component and the label reference (LABEL_REF) component enable two or more flowchart components, which are spaced apart from each other, to be substantially connected, and at least one of a label name and a color is set for the label (LABEL) component and the label reference (LABEL_REF) component to enable identification.

More preferably, the method for generating instruction codes further comprises: determining whether at least one of a target component, a property, and a value of the first flowchart instance, and at least one of a target component, a property, and a value of the second flowchart instance conform to an input rule; and detecting an error.

More preferably, at least one of the flowchart components matches at least two instructions, and the method for generating instruction codes further comprises determining one instruction based on at least one of a target component, a property, and a value of the first flowchart instance.

More preferably, the method for generating instruction codes includes determining a register address and data of the instruction based on at least one of a target component, a property, and a value of the first flowchart instance.

Preferably, the target component comprises at least one of: a reset component, an isolation component, a switch control component, a retention component, an automatic power manager component, a reference clock gating component, a memory component, a handshake component, a clock link component, a P-channel handshake component, a user-defined output component, and a user-defined input component.

Preferably, the target component comprises at least one of: an information register generation component, a timeout register generation component, an upper-level information transfer register generation component, an internal register storage component, an internal register control interrupt generation component, an external input control interrupt generation component, a timer generation component, and a domain power manager connection component.

A computer program stored in a computer-readable medium is provided for executing the aforementioned method according to an embodiment of the present disclosure on a computer.

### Advantageous Effects

In various embodiments of the present disclosure, a flowchart-based user interface is provided to an operator, allowing instruction codes of a microcontroller unit to be generated more simply and efficiently.

In various embodiments of the present disclosure, when the operator defines an operation process of the microcontroller unit using the flowchart-based user interface, instruction codes of the microcontroller unit can be automatically generated based on the defined operation process.

In various embodiments of the present disclosure, because errors in the information input through the flowchart-based user interface are checked before generating instruction codes of the microcontroller unit, the likelihood of an error in the instruction codes can be reduced.

In various embodiments of the present disclosure, since the operator does not need to directly code using a programming language, even a person without knowledge of programming language-based coding can design instruction codes of the microcontroller unit, and the efficiency of the design process can be effectively improved.

The effects of the present disclosure are not limited to those described above, and other effects not mentioned herein will be clearly understood by those of ordinary skill in the art from the description of the claims.

### BRIEF DESCRIPTION OF THE DRAWINGS

Embodiments of the present disclosure will be described with reference to the accompanying drawings described below, in which similar reference numerals indicate similar elements, but are not limited thereto.

FIG. 1 is a configuration diagram illustrating a system-on-chip (SoC) to be designed in the present disclosure.

FIG. 2 is a configuration diagram illustrating a domain power manager of FIG. 1.

FIG. 3 is a diagram illustrating an example of a power-up sequence and a power-down sequence performed in the domain power manager of the present disclosure.

FIG. 4 is a diagram illustrating a system for generating instruction code of a microcontroller unit according to an embodiment of the present disclosure.

FIG. 5 is a diagram illustrating an example of a display screen of the instruction code generation system of the microcontroller unit according to an embodiment of the present disclosure.

FIG. 6 is a diagram illustrating an example of flowchart component icons used in an embodiment of the present disclosure.

FIG. 7 is a diagram illustrating an example of an operation process diagram of the microcontroller unit displayed in a design window.

FIG. 8 is a diagram illustrating an example of instruction code converted based on the operation process of FIG. 7.

FIG. 9 is a flowchart illustrating a method for generating instruction code of a microcontroller unit according to an embodiment of the present disclosure.

FIG. 10 is a diagram illustrating an example of a computing device for performing the above-described method and/or embodiments.

### DETAILED DESCRIPTION

Hereinafter, specific details for implementing the present disclosure will be described in detail with reference to the accompanying drawings. However, in the following description, detailed explanations of well-known functions or configurations will be omitted when such descriptions are deemed to unnecessarily obscure the essence of the present disclosure.

In the accompanying drawings, the same or corresponding components are denoted by the same reference numerals. In addition, in the following description of the embodiments, repeated descriptions of the same or corresponding components may be omitted. However, omission of the description of a component does not imply that the component is not included in the embodiment.

The advantages and features of the embodiments disclosed in the present disclosure, and methods for achieving them, will become apparent from the embodiments described below with reference to the accompanying drawings. However, the present disclosure is not limited to the embodiments set forth below, and may be implemented in various different forms. The embodiments are provided solely to fully inform those skilled in the art of the scope of the present disclosure.

The terms used in the present disclosure will be briefly described, and the disclosed embodiments will be specifically explained. The terms used in the present disclosure have been selected as generally used terms that are as commonly used as possible at present in consideration of the functions of the present disclosure, but their meanings may vary depending on the intention of those skilled in the art, precedents, or the emergence of new technologies. In certain cases, terms may have been arbitrarily selected by the applicant, and in such cases, their meanings will be described in detail in the relevant part of the description of the invention. Accordingly, the terms used in the present disclosure should not be interpreted merely by their names but should be defined based on their meanings and the overall content of the present disclosure.

As used herein, singular expressions shall be understood to include plural expressions unless clearly specified as singular in context. Likewise, plural expressions shall be understood to include singular expressions unless clearly specified as plural in context. Throughout the specification, when a portion is described as including a component, it shall be understood that the portion does not exclude the presence of one or more other components unless explicitly stated otherwise.

In the present disclosure, the terms “comprise,” “comprising,” and the like are intended to specify the presence of features, steps, operations, elements, and/or components, but do not preclude the presence or addition of one or more other features, steps, operations, elements, components, and/or combinations thereof.

In the present disclosure, when a particular component is referred to as being “coupled,” “combined,” “connected,” “associated,” or “responsive” to any other component, the particular component may be directly coupled, combined, connected, associated, or responsive to the other component, but is not limited thereto. For example, one or more intermediate components may be interposed between the particular component and the other component. Furthermore, the term “and/or” used in the present disclosure is intended to include any and all combinations of one or more of the listed items, or at least a portion thereof.

In the present disclosure, the terms “first,” “second,” and the like are used merely for distinguishing one component from another and should not be construed as limiting. For example, a “first” component may refer to the same or a similar component as a “second” component.

In various embodiments of the present disclosure, a flowchart component may refer to a tool that can be utilized to design an operation process of a microcontroller unit. The flowchart component may include: a write (WRITE) component for writing a specific value to a specific register field; an input wait (READWAIT) component for waiting for a specific value to be input into a specific register field; a wait (WAIT) component for waiting for a predetermined period of time; a condition (IF) component for branching based on a condition; a move (GOTO) component for moving to a specific location; a call (CALL) component for moving to a specific location while allowing a return; a label (LABEL) component; a start (START) component; and an end (END) component.

A flowchart instance may refer to a flowchart component added to a design window by a user operation. Each flowchart instance may be configured with a target component and at least one of a property or a value. Here, the target component may be a power component. Based on the type of the flowchart instance, the target component, and at least one of the property or the value, an assembly instruction of the microcontroller unit may be determined, and data corresponding to an input format of the determined assembly instruction may be determined.

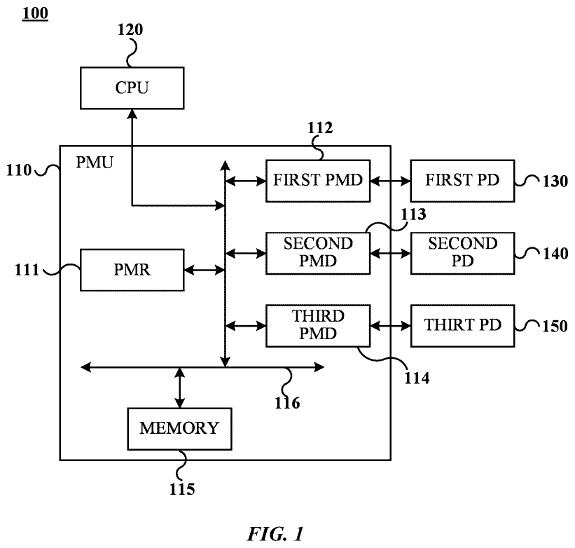

FIG. 1 is a configuration diagram of a system-on-chip (SoC) to be designed in the present disclosure. The system-on-chip device 100 includes a complete product and system that are fully operable within a single integrated circuit, and may be implemented as a chip, a module, or a system.

The system-on-chip device 100 may include a power management unit (PMU) 110, a central processing unit (CPU) 120 configured to control the power management unit 110 through software, and at least one power domain (PD) 130, 140, or 150. The central processing unit 120 controls the power management unit 110 and may constitute one of the power domains included in the system-on-chip device 100. That is, the central processing unit 120 and the first power domain 130 may be the same component.

The power management unit 110 may provide a power-up/power-down sequence corresponding to each of the power domains 130, 140, and 150. Each power domain 130, 140, and 150 may process the power-up/power-down sequence to enter a power-up state or a power-down state. The system-on-chip device 100 may include at least one power management unit 110.

The power management unit 110 may include: at least one domain power manager (PMD; Power Management for Domain) 112, 113, or 114, each corresponding to and controlling a respective power domain 130, 140, or 150; a root power manager (PMR; Power Management for Root) 111 configured to manage the at least one domain power manager 112, 113, or 114; and a memory 115 configured to store a program for operating the root power manager 111 and the at least one domain power manager 112, 113, or 114. The at least one domain power manager 112, 113, or 114, the root power manager 111, and the memory 115 may be interconnected via an internal bus 116.

The root power manager 111 and each of the at least one domain power managers 112, 113, and 114 may be implemented as a microcontroller unit (MCU). In addition, instruction codes corresponding to the operation processes of the root power manager 111 and the at least one domain power manager 112, 113, and 114 may be stored in the memory 115.

The root power manager 111 may receive a system power-up/power-down command from the central processing unit 120. At the time of booting, the root power manager 111 may operate the at least one domain power manager 112, 113, or 114 based on an instruction code for performing booting, thereby performing booting of the system-on-chip device 100. In addition, when a system power-up/power-down command is received from the central processing unit 120, the root power manager 111 may operate the at least one domain power manager 112, 113, or 114 based on an instruction code for executing the command, thereby powering on or powering off the system-on-chip device 100.

When a domain power-up/power-down command for controlling the power of a power domain is received from the central processing unit 120, at least one of the domain power managers 112, 113, and 114 may perform power-up/power-down sequence control on the corresponding power domain based on an instruction code for executing the command.

The memory 115 may store, as binary code, an instruction code for the root power manager 111 to perform a system power-up/power-down command, and may also store, as binary code, an instruction code for each of the domain power managers 112, 113, and 114 to perform a domain power-up/power-down command.

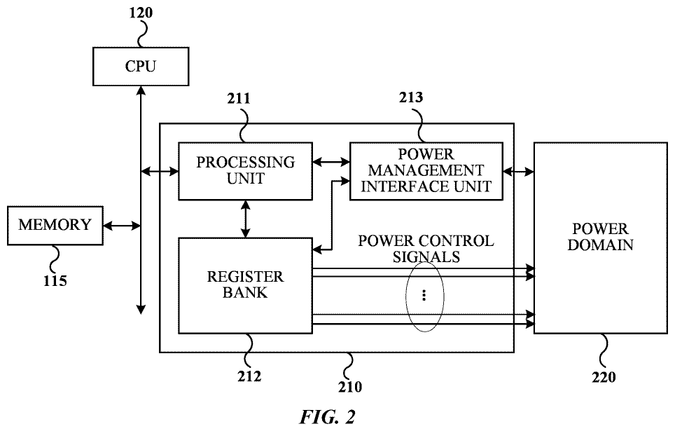

FIG. 2 is a configuration diagram illustrating the domain power manager 210 of FIG. 1. The domain power manager 210 may be an example of a microcontroller unit.

The domain power manager 210 transmits power control signals to the power domain 220 to perform a power-up/power-down sequence of the power domain 220, and transitions from a power-up state to a power-down state or from a power-down state to a power-up state. The power control signals for performing the power-up/power-down sequence may include a reset signal (Reset), an isolation signal (Isolation), a switch control signal (Switch Control), and a retention signal (Retention). These power control signals may be added, removed, or modified according to the specifications of the power domain 220.

The domain power manager 210 of FIG. 2 may be one of the first domain power manager 112, the second domain power manager 113, or the third domain power manager 114 of FIG. 1. The power domain 220 of FIG. 2 may be one of the power domains 130, 140, or 150 of FIG. 1. When designing the domain power manager, an instruction code corresponding to the operation process to be performed by the domain power manager 210 may be stored in the memory 115.

The domain power manager 210 includes: a processing unit 211 configured to receive a domain power-up/power-down command related to power control of the power domain 220 from the central processing unit 120, access a memory 115 in which an instruction code for executing the command is stored, and execute the instruction code stored in the memory 115; a register bank 212 in which at least one field value is changed by the processing unit 211 such that power control signals are transmitted to the power domain 220. The processing unit 211 may include a plurality of power components, each of which may correspond to one of the power control signals. The domain power manager 210 may further include a power management interface unit 213 configured to receive a signal from the power domain 220 and transmit the signal to at least one of the processing unit 211 and the register bank 212.

The processing unit 211 may include at least one of the following power components: a power component for transmitting a reset signal to the power domain; a power component for transmitting an isolation signal to the power domain; a power component for transmitting a switch control signal to the power domain; a power component for transmitting a retention signal to the power domain; a power component for automatically performing power-up/power-down by a hardware trigger signal; a power component for gating a reference clock supplied to the power domain; a power component for generating a power control signal to a memory in the power domain; a power component for generating a handshake control signal with the power domain; a power component for generating a link control signal with a clock management unit; a power component for generating a P-channel handshake control signal with the power domain; a power component for generating a user-defined output signal within the power domain; and a power component for generating a user-defined input signal within the power domain. The power components constituting the processing unit 211 may be set as target components of a flowchart instance in a system for generating instruction code according to an embodiment of the present disclosure.

The register bank 212 may include a plurality of register fields corresponding to the power components constituting the processing unit 211. A power component responsible for transmitting and receiving power control signals to and from the power domain may change the value of the corresponding register field, and the value written in the corresponding register field may be transmitted to the power domain 220 as the corresponding power control signal. For example, a power component for transmitting a reset signal may change the value of a register field corresponding to the reset signal of the register bank 212 to 0 or 1, in which case 0 or 1 may be transmitted to the reset port of the power domain. Similarly, a power component for transmitting an isolation signal may change the value of a register field corresponding to the isolation signal of the register bank 212 to 0 or 1, in which case 0 or 1 may be transmitted to the isolation port of the power domain. Likewise, a power component corresponding to a switch control signal or a retention signal may respectively change the value of a register field corresponding to the switch control signal or the retention signal of the register bank 212 to 0 or 1, and 0 or 1 may be transmitted to the switch control port or the retention port of the power domain, respectively. For such operation of the processing unit, the memory 115 may further store an instruction and a register field address of the target component that is the execution target of the instruction.

The types and operations of the instructions according to an embodiment of the present disclosure are summarized in Table I below. An input format may be predetermined for each 5 instruction.

TABLE 1

| Instructions | Operations |
|---|---|
| Write_bit_0 | Write 0 to a specific register field of the register bank |
| Write_bit_1 | Write 1 to a specific register field of the register bank |
| Readwait_bit_0 | Wait until the value of a specific register field of |
| | the register bank becomes 0 |
| Readwait_bit_1 | Wait until the value of a specific register field of the |
| | register bank becomes 1 |
| If_bit | Branch based on whether the value of a specific |
| | register field of the register bank is 1 or 0 |
| load | Copy the value of a specific register field of the |
| | register bank to an internal register of the |
| | processing unit. |
| Store | Copy the value of an internal register of the processing |
| | unit to a specific register field of the register bank. |
| Load_constant | Write a constant value to a specific register field of |
| | the register bank |
| pop | Return to the previous program counter (PC) value |
| | stored in the current stack |
| branch | Jump to a specific program counter (PC) value |
| Branch_if0 | If the field value checked by IF_BIT is 0, jump to a |
| | specific program counter (PC) value. |
| Branch_if1 | If the field value checked by IF_BIT is 1, jump to a |
| | specific program counter (PC) value. |
| Branch_linked | Copy the current program counter (PC) to the stack |
| | and jump to a specific program counter value |
| Wait_cycles | Wait for a constant number of cycles |
| Wait_cycles_r | Wait for cycles based on the value of a specific |
| | register field |

The instruction stored in the memory 115 may include at least one of Write_bit_0 and Write_bit_1, and the processing unit 211 may execute Write_bit_0 or Write_bit_1 to change the value of a specific register field in the register bank 212 to 0 or 1. Then, the value of the corresponding power control signal may be set to 0 or 1 and transmitted to the power domain 220.

Among the power control signals, many are implemented as handshake signals. For example, after a power switch enable signal is transmitted, it is necessary to wait until a corresponding feedback signal is received. In this case, the feedback signal output from the power domain is written to a specific register field of the register bank 212 via the power management interface unit 213. To this end, the instruction stored in the memory 115 may include at least one of Readwait_bit_0 and Readwait_bit_1, and the processing unit 211 may execute Readwait_bit_0 or Readwait_bit_1 to wait until the value of the specific register field in the register bank 212 becomes 0 or 1.

In addition, among the power control signals, it may be necessary to wait for a predetermined period of time after transmitting a signal before performing the next operation. For example, when the power domain 220 is reset-released, it is necessary to wait until the power domain 220 completes its reset process and begins normal operation. To this end, the instruction stored in the memory 115 may include at least one of wait_cycles or wait_cycles_r. The processing unit 211 may execute wait_cycles or wait_cycles_r to wait for a number of cycles defined by a specific constant value or a specific register field value.

In addition, the instructions stored in the memory 115 may include: a store instruction configured to write a value of an internal register of the processing unit 211 to a specific register field of the register bank 212; a load instruction configured to write a value of a specific register field of the register bank 212 to an internal register of the processing unit 211; and a load_constant instruction configured to write a user-input constant value to an internal register of the processing unit 211.

In addition, the instructions stored in the memory 115 may include instructions for determining an execution order of the instructions stored in the memory 115. Such instructions may include: a branch instruction configured to jump to a specific program counter; a pop instruction configured to return to a previous program counter; branch_if0 and branch_if1 instructions configured to move to a specific program counter based on the result of instruction execution; and a branch_linked instruction configured to store the current program counter and jump to a specific program counter.

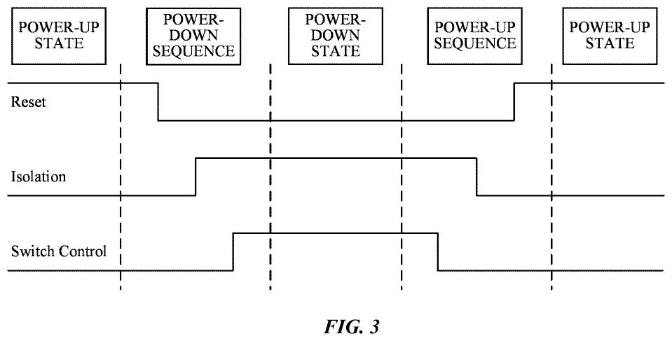

FIG. 3 is a diagram illustrating an example of a power-up sequence and a power-down sequence performed by the domain power manager according to an embodiment of the present disclosure.

When the power domain 220 is in a power-up state, if the reset signal transitions from 1 to 0, the isolation signal transitions from 0 to 1, and the switch control signal transitions from 0 to 1, it is assumed that the power domain enters a power-down state. The set of power control signals that cause the power domain 220 to transition from the power-up state to the power-down state is referred to as a power-down sequence. Conversely, when the power domain 220 is in a power-down state, if the switch control signal transitions from 1 to 0, the isolation signal transitions from 1 to 0, and the reset signal transitions from 0 to 1, it is assumed that the power domain enters a power-up state. The set of power control signals that cause the power domain 220 to transition from the power-down state to the power-up state is referred to as a power-up sequence.

The domain power manager 210 may perform a power-up sequence and a power-down sequence for the power domain 220, and the power domain 220 may transition to a power-up state or a power-down state by executing the power-up sequence and the power-down sequence.

When instructions for the domain power manager 210 to perform power control on the power domain 220 are stored in the memory 115, the central processing unit 120 may transmit a domain power-up command or a domain power-down command to the domain power manager 210.

When a domain power-down command is received from the central processing unit 120, the domain power manager 210 reads and executes an instruction code from the memory 115 to perform a power-down sequence in the power domain 220. The instruction code may include an instruction for setting a specific register field value of the register bank 212 to 0 or 1, and by executing such instruction, the power-down sequence may be carried out in the power domain 220 as illustrated in FIG. 3.

When a domain power-up command is received from the central processing unit 120, the domain power manager 210 reads and executes an instruction code from the memory 115 to perform a power-up sequence in the power domain 220. As a result, the power-up sequence may be carried out in the power domain 220 as illustrated in FIG. 3.

Similar to the domain power manager described above, the root power manager may also be implemented as a microcontroller unit. A program including instruction codes to be executed by the root power manager may be stored in the memory. The central processing unit may transmit a system power-up or power-down command to the root power manager.

Instruction codes to be executed by the root power manager in response to the system power-up or power-down command may be stored in the memory. Upon receiving the system power-up or power-down command from the central processing unit, the root power manager executes the instruction codes stored in the memory and transmits power control signals to at least one of the domain power managers to control power.

The memory stores a program including instruction codes for domain power-up/power-down and system power-up/power-down, and the program stored in the memory may be executed by the domain power manager and/or the root power manager, each implemented as a microcontroller unit.

Accordingly, it is necessary to design instruction codes for respective operation processes so that the microcontroller unit can operate as either the domain power manager or the root power manager.

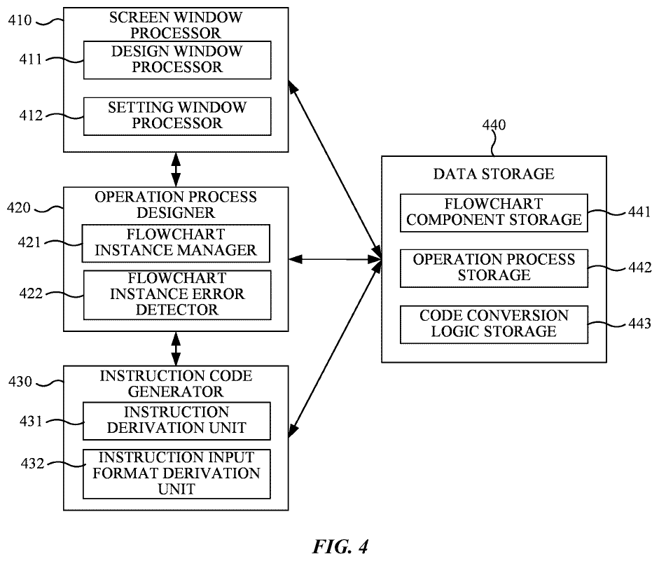

FIG. 4 is a diagram illustrating a system for generating instruction codes for a microcontroller unit according to an embodiment of the present disclosure. The instruction code generation system for the microcontroller unit may be configured to enable the microcontroller unit to operate as at least one of the root power manager and the domain power manager shown in FIG. 1.

The instruction code generation system for a microcontroller unit according to an embodiment of the present disclosure may include: a screen window processor 410 configured to detect user input and display the result of processing the user input on a display screen; an operation process designer 420 configured to receive a flowchart instance based on at least one flowchart component, and to set an operation process of the microcontroller unit by receiving a target component and at least one property or value; an instruction code generator 430 configured to convert the operation process of the microcontroller unit into instruction codes; and a data storage 440 configured to store information on the flowchart components, the designed operation process, and code conversion logic for converting the operation process into instruction codes.

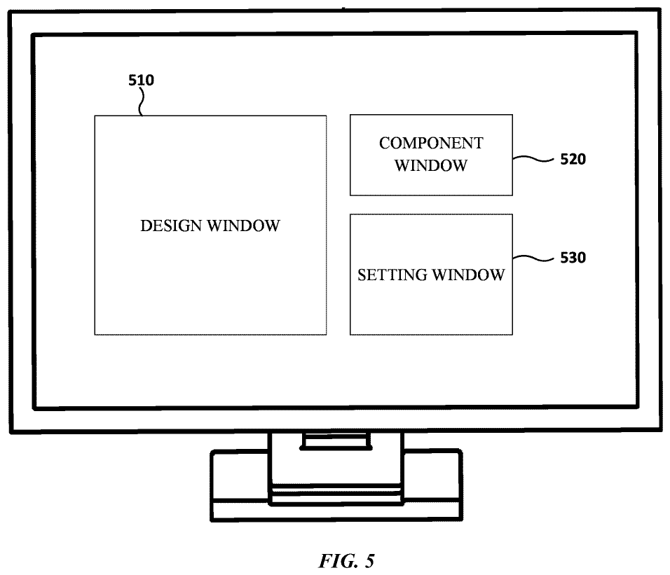

FIG. 5 is a diagram illustrating an example of a display screen of the instruction code generation system for a microcontroller unit according to an embodiment of the present disclosure.

The display screen of the design system according to an embodiment of the present disclosure may include: a component window 520 in which flowchart component icons are displayed; a design window 510 that provides an environment for adding, deleting, or modifying a flowchart instance based on the flowchart components, allowing a user to design an operation process of the microcontroller unit; and a setting window 530 that provides an input environment for a target component and at least one property or value of a flowchart instance selected in the design window 510.

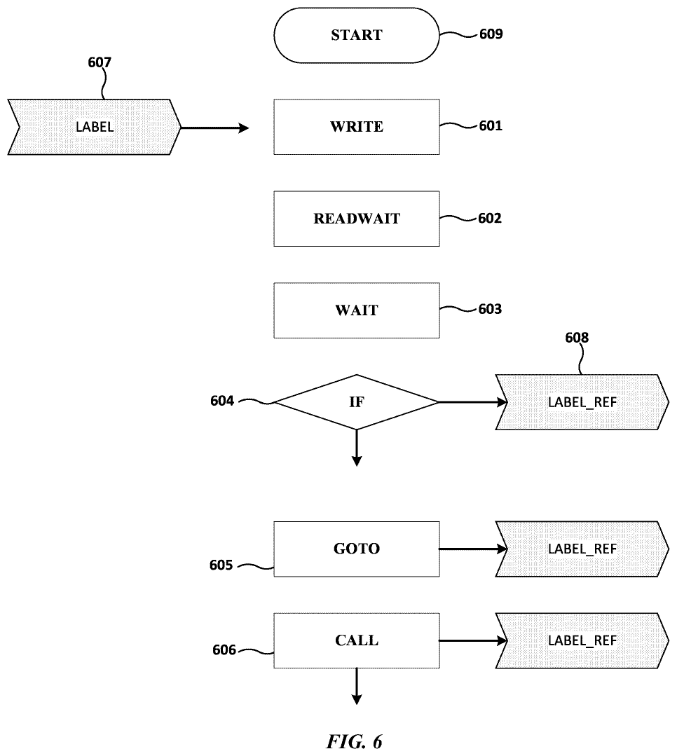

The component window 520 may display a list of at least one flowchart component icon. FIG. 6 illustrates an example of flowchart component icons used in an embodiment of the present disclosure. The flowchart components may include: a write (WRITE) component 601 configured to write a specific value to a specific register field; an input wait (READWAIT) component 602 configured to wait until a specific value is input to a specific register field; a wait (WAIT) component 603 configured to wait for a predetermined period of time; a condition (IF) component 604 configured to branch according to a condition; a move (GOTO) component 605 configured to move to a specific location; and a call (CALL) component 606 configured to move to a specific location and return. In addition, the flowchart components may further include a label (LABEL) component 607, a label reference (LABEL_REF) component 608, a start (START) component 609, and an end (END) component (not shown).

Each flowchart component may have a unique border shape. For example, the write component 601, the input wait component 602, and the wait component 603 may have rectangular borders; the condition component 604 may have a diamond-shaped border; and the label component 607 and the label reference component 608 may have arrow-shaped borders. Two or more label components 607 and label reference components 608 may be used in the design window, and a label name and color may be assigned to each of the label components 607 and label reference components 608 for identification.

A label component 607 may be connected to a front end of each flowchart component, and the corresponding flowchart component may be executed through the label component 607. A label reference component 608 may be connected to a rear end of the condition component 604, the move component 605, or the call component 606. Each of the label components 607 and label reference components 608 may be identified by a label name. A label reference component 608 and a label component 607 having the same label name may substantially connect a flowchart component located at a front end of the label reference component 608 with a flowchart component located at a rear end of the label component 607. Accordingly, when designing a flowchart-based operation process, arrow connections can be made in a clean and organized manner without complex entanglements, thereby improving readability.

Two adjacent flowchart components may be connected by an arrow. The arrow may represent a temporal order of the operation process of the microcontroller unit. Each flowchart component may be configured such that a target component and at least one property or value are additionally input, and connection rules for arrows between any two adjacent flowchart components may be defined.

For example, the write (WRITE) component 601 may have a target component set, and either a single-bit or multi-bit may be set as a property. When a single-bit is set as the property, the value may be limited to 0 or 1, and if the value is other than 0 or 1, an error (sanity error) may occur. When a multi-bit is set as the property, the value must be within the maximum value expressible by the corresponding number of bits. For example, if a 4-bit is set as the property, the value must be between 0 and 15, and an error may occur if the value is 16 or greater.

The input wait (READWAIT) component 602 may have a target component set, and either a single-bit or a multi-bit may be set as a property. When a single-bit is set as the property, the value may be limited to 0 or 1, and if the value is other than 0 or 1, an error may occur. When a multi-bit is set as the property, the value must be within the maximum value expressible by the corresponding number of bits, and if the value exceeds the maximum value, an error may occur.

The wait (WAIT) component 603 may have only a value input, or may have only a target component and a property input. When only a value is input to the wait (WAIT) component 603, it may wait for the number of cycles corresponding to the value. When a target component and a property are input to the wait (WAIT) component 603, it may read a field value of the target component and wait for the number of cycles corresponding to the read value. That is, the wait (WAIT) component 603 must either have only a value input or have a target component and a property input. If the input does not comply with this rule, an error may occur.

The condition (IF) component 604 may proceed to the lower rear end in the case of a true condition and to the right rear end in the case of a false condition, depending on the evaluation condition. A label reference component (LABEL_REF) may be set to be connected to the right rear end of the condition (IF) component 604, and a label name must be set for the label reference component (LABEL_REF). If the label name is not set, an error may occur.

The move (GOTO) component 605 may be set such that it does not include a lower rear end, and a label reference component (LABEL_REF) with a set label name is connected to its right rear end. If the label name is not set for the label reference component (LABEL_REF), an error may occur.

The call (CALL) component 606 may be set such that a label reference component (LABEL_REF) is connected to its right rear end, and a label name must be set for the label reference component (LABEL_REF); if the label name is not set, an error may occur. The call (CALL) component may move to the label component (LABEL) through the label reference component (LABEL_REF), and then return to execute the flowchart component located at its lower rear end.

Herein, the target component may be a power component when the microcontroller unit to be designed is a domain power manager or a root power manager, but is not limited thereto, and the target component may be determined according to the type of the microcontroller unit to be designed.

The power component may include: a reset component for transmitting a reset signal to the power domain; an isolation component for transmitting an isolation signal to the power domain; a switch control component for transmitting a switch control signal to the power domain; a retention component for transmitting a retention signal to the power domain; an automatic power manager component for automatically performing power-up/power-down by a hardware trigger signal; a reference clock gating component for gating a reference clock supplied to the power domain; a memory component for generating a power control signal to a memory of the power domain; a handshake component for generating a handshake control signal with the power domain; a clock link component for generating a link control signal with a clock management unit; a P-channel handshake component for generating a P-channel handshake control signal with the power domain; a user-defined output component for generating a user-defined output signal within the power domain; and a user-defined input component for generating a user-defined input signal within the power domain.

In addition, the power component may include: a component for generating a register used by software for information purposes; a component for generating a register used by software for timeout purposes; a component for generating a register used for delivering information between upper-layer software and the root power manager; a component for storing specific signal values input to the root power manager in an internal register of the root power manager; a component for generating an interrupt under the control of an internal register of the root power manager; a component for generating an interrupt by an external input received at an input port of the root power manager; a component for generating an internal timer; and a component for generating a slot for connecting a domain power manager subordinate to the root power manager.

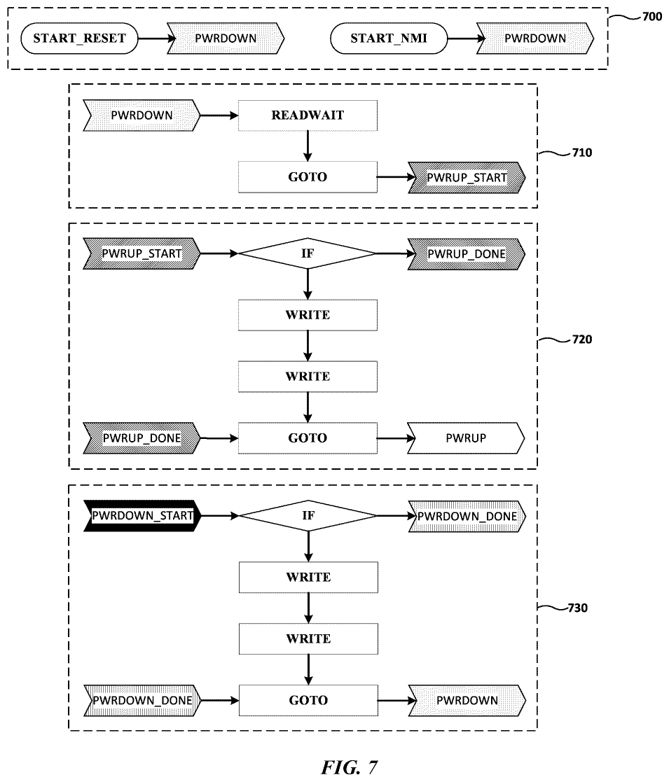

The design window 510 may display the operation process of the microcontroller unit as a flowchart diagram. FIG. 7 is a diagram illustrating an example of an operation process diagram of the microcontroller unit displayed in the design window. When a user moves any flowchart component from the component window 520 to the design window 510 through a drag-and-drop operation, a flowchart instance corresponding to the flowchart component may be generated. The connection relationship between flowchart instances may be indicated by arrows connecting the flowchart instances, and this connection relationship may determine the execution order of the flowchart instances.

In the default group 700, the operation process diagram may include two start instances: START_RESET and START_NMI. The default group 700 may be configured such that it is not editable by the user. When the microcontroller unit is reset, the “PWRDOWN” label instance of the first group 710 may be executed through the start instance START_RESET. When the microcontroller unit receives an interrupt, the “PWRDOWN” label instance of the first group 710 may be executed through the start instance START_NMI.

In the first group 710, the “PWRDOWN” label instance, an input wait (READWAIT) instance, a move (GOTO) instance, and a “PWRUP_START” label reference instance may be sequentially connected. A target component, a property, and a value may be input to the input wait instance.

Through the “PWRUP_STAR” label reference instance of the first group 710, the flow may proceed to the “PWRUP_START” label instance of the second group 720, and a condition (IF) instance, two write (WRITE) instances, and a move (GOTO) instance may be executed. For each flowchart instance, a target component and at least one of a property or a value may be set.

The third group 730 may be executed through an unillustrated “PWRDOWN start” label reference instance, and a condition (IF) instance, two write (WRITE) instances, and a move (GOTO) instance may be executed. A “PWRDOWN” label reference instance may be set to return to the “PWRDOWN” label instance of the first group 710.

The connection relationship between flowchart instances may be indicated by arrows connecting the flowchart instances, and such a relationship may determine the execution order of the flowchart instances. A user may design the operation process of the microcontroller unit by expressing it in the form of a flowchart diagram.

The setting window 530 may provide an environment for selecting and modifying a target component, a property, and a value for a flowchart instance selected in the design window 510, and may also provide an environment for inputting and modifying a label name and a color of label instances and label reference instances.

The screen window processor 410 may include a design window processor 411 configured to detect user input in the design window 510 and to perform an operation corresponding to the user input, and a setting window processor 412 configured to display setting information of a flowchart instance selected by the user in the setting window 530, to detect user input in the setting window 530, and to perform a corresponding operation.

The design window processor 411 is configured to cause an operation process diagram of the microcontroller unit to be displayed in the design window 510. When the user performs an operation to add any flowchart component from the component window 520 to the design window 510, the design window processor 411 is configured to detect the operation and to cause a flowchart instance to be added. The setting window processor 412 is configured to cause setting information of a flowchart instance selected by the user to be displayed in the setting window 530, to detect user input in the setting window 530, and to perform an operation corresponding to the user input.

The data storage 440 may include: a flowchart component storage 441 configured to store flowchart component information; an operation process storage 442 configured to store at least one flowchart instance along with a target component, a property, or a value of each flowchart instance, as part of an operation process of the microcontroller unit designed by a user; and a code conversion logic storage 443 configured to store code conversion logic for converting the designed operation process into instruction code. The instruction code for the operation process of the microcontroller unit may include an instruction, a register address, and data.

The flowchart components stored in the flowchart component storage 441 may include: a write (WRITE) component for writing a specific value to a specific register field; an input wait (READWAIT) component for waiting for a specific value to be input to a specific register field; a wait (WAIT) component for waiting for a predetermined period of time; a condition (IF) component for branching based on a condition; a move (GOTO) component for jumping to a specific location; a call (CALL) component for jumping to a specific location with a return path; a start (START) component; and an end (END) component. Each flowchart component may have a label (LABEL) component set at its front end, and some flowchart components may have a label reference (LABEL_REF) component set at their rear end. The flowchart components may have unique border shapes and colors, and some flowchart components may be configured to have a target component set.

The target component may be a power component, and the power component may include at least one of: a reset component, an isolation component, a switch control component, a retention component, an automatic power manager component, a reference clock gating component, a memory component, a handshake component, a clock link component, a P-channel handshake component, a user-defined output component, and a user-defined input component.

In addition, the power component may include at least one of: a component configured to generate a register used for information purposes in software; a component configured to generate a register used for timeout purposes in software; a component configured to generate a register used for information delivery between upper-level software and the root power manager; a component configured to store specific signal values input to the root power manager into an internal register of the root power manager; a component configured to generate an interrupt based on control by the internal register of the root power manager; a component configured to generate an interrupt in response to an external input received at an input port of the root power manager; a component configured to generate an internal timer; and a component configured to generate a slot for connecting a domain power manager subordinate to the root power manager.

The operation process storage 442 stores flowchart instances set for driving the microcontroller unit, including execution order information of the flowchart instances, and stores at least one of a target component, a property, and a value for each flowchart instance. When a user drags and drops a flowchart component into the design window 640, a flowchart instance based on the corresponding flowchart component may be generated. In this case, a target component, a property, and a value for the flowchart instance may be set. That is, when the flowchart component is a write component, it is necessary to set which value (i.e., data and its property) is to be written to which power component (e.g., a reset component or an isolation component). The target component corresponds to the relevant power component, the value corresponds to the data to be written, and the property may correspond to an attribute of the value (e.g., 1-bit, 4-bit). Since a register region is defined for each target component, once the target component of a flowchart instance is determined, the register field address of the corresponding power component may be determined.

In order to design a microcontroller unit that operates from a power-up state to a power-down state as shown in FIG. 3, the information stored in the operation process storage 442 may be represented in the order of “flowchart instance-target power component-property-value,” as illustrated below:
1. Write instance-reset component-1 bit-0
2. Write instance-isolation component-1 bit-1
3. Write instance-switch control component-1 bit-1

Next, in order to design a microcontroller unit that operates from a power-down state to a power-up state, the information stored in the operation process storage 442 may be represented in the order of “flowchart instance-target power component-property-value,” as illustrated below.
1. Write instance-switch control component-1 bit-0
2. Write instance-isolation component-1 bit-0
3. Write instance-reset component-1 bit-1

The target power component may be one of at least one power component that constitutes the microcontroller unit being designed.

The value may be input in decimal or hexadecimal format.

The code conversion logic storage 443 may store code conversion logic for generating instruction code for executing the microcontroller unit based on the operation process of the designed microcontroller unit.

The operation process designer 420 may receive a flowchart instance based on at least one flowchart component, and may further receive at least one of a target component, a property, and a value to set the operation process of the microcontroller unit. The operation process designer 420 may include a flowchart instance manager 421 that stores information on at least one flowchart instance and performance order information between any two flowchart instances in the operation process storage 442, and a flowchart instance error detector 422 that detects whether the input of a flowchart instance complies with rules and whether the arrow connection between any two adjacent flowchart instances is a rule-compliant connection.

As described above, a flowchart instance may have a target component, a property, and a value input thereto. The flowchart instance manager 422 may store the target component, property, and value input for each flowchart instance, and may store arrow information indicating the connection between any two flowchart instances.

The flowchart instance error detector 422 detects whether there is an error in the input information of a flowchart instance input to the flowchart instance manager 421, and detects whether an arrow connecting any two flowchart instances conforms to a connection rule, in order to detect errors in the operation process. For example, if a value input for a write (WRITE) instance exceeds the range defined by its property, an error is generated, and similarly, if a value input for an input wait instance exceeds the range defined by its property, an error is also generated.

In addition, an error may be generated by detecting whether the value, or the combination of target component and property, for the wait instance is set according to the input rules. An error may also occur if the label name of a label reference instance is not set to match that of a previously generated label instance. Furthermore, for a move instance or a call instance, an error may occur if the direction of the arrow is incorrect or if the label reference instance is not connected.

The instruction code generator 430 converts the operation process of the microcontroller unit, as designed in the operation process designer 420, into instruction code. The instruction code generator 430 may include: an instruction derivation unit 431 configured to determine an assembly instruction based on at least one of a flowchart instance, a target component, a property, and a value; and an instruction input format derivation unit 432 configured to determine at least one of a register address and data according to the input format of the instruction determined based on at least one of a target component, a property, and a value.

In the case of a write instance, if the property is 1-bit and the value is 0, the instruction is determined as write_bit_0, and the register address corresponding to the target component is determined as the input format. If the property is 1-bit and the value is 1, the instruction is determined as write_bit_1, and the register address corresponding to the target component is likewise determined as the input format. In a write instance where the property is multi-bit, two instructions—load_constant and store—may be determined.

In the case of an input wait instance, if the property is 1-bit and the value is 0, the instruction is determined as readwait_bit_0, and the register address corresponding to the target component is determined as the input format. If the property is 1-bit and the value is 1, the instruction is determined as readwait_bit_1, and the register address corresponding to the target component is determined as the input format. In an input wait instance where the property is multi-bit, a number of readwait_bit_0 or readwait_bit_1 instructions corresponding to the bit width may be determined depending on the value.

In the case of a wait instance, if only the value is input, the instruction may be determined as wait_cycles. If both the target component and the property are input, the instructions may be determined as load and wait_cycles_r, respectively.

Similarly, the condition instance may be determined as a combination of an if_bit instruction and either a branch_if0 or branch_if1 instruction. The move instance may be determined as a branch instruction, and the call instance may be determined as a branch_linked instruction.

Each flowchart instance is connected by an arrow. When an instruction code is generated based on each flowchart instance, the program counter of each instruction may be incremented by a fixed size (for example, 4 bytes).

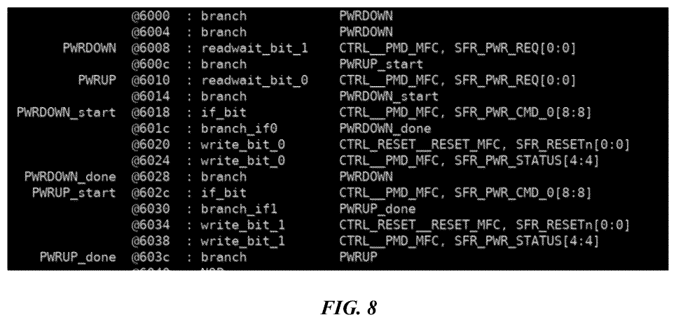

FIG. 8 is a diagram illustrating an example of instruction code converted based on the operation process of FIG. 7.

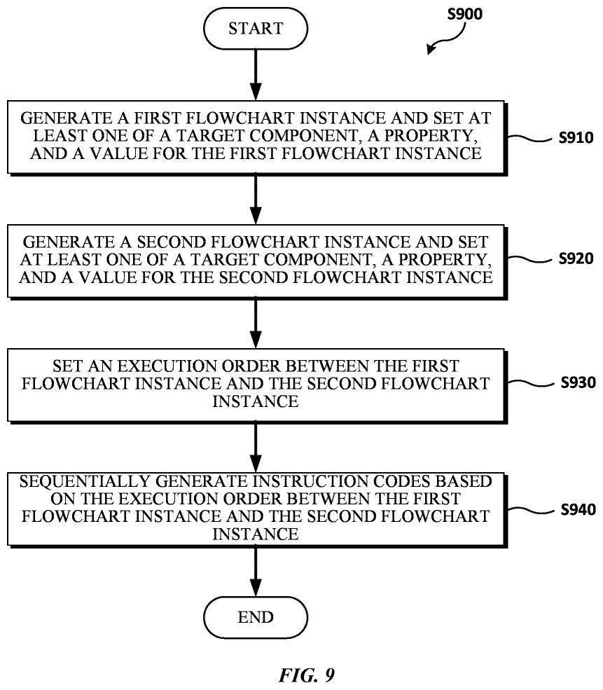

FIG. 9 is a flowchart illustrating a method for generating instruction code of a microcontroller unit according to an embodiment of the present disclosure. The method for generating instruction code of the microcontroller unit according to the present disclosure may be executed by a processor of a computer system.

The processor generates a first flowchart instance based on a flowchart component and sets at least one of a target component, a property, and a value for the generated first flowchart instance (S910). The target component, property, and value of the first flowchart instance may be set through user input, and if the input does not conform to the input rules, an error may occur.

The processor generates a second flowchart instance based on a flowchart component and sets at least one of a target component, a property, and a value for the generated second flowchart instance (S920). The target component, property, and value of the second flowchart instance may be set through user input, and if the input does not conform to the input rules, an error may occur.

The processor sets the execution order of the first flowchart instance and the second flowchart instance (S930). The execution order of the first flowchart instance and the second flowchart instance may be set through user input and may be represented by an arrow connection. An error may occur if the arrow connection between the first flowchart instance and the second flowchart instance does not conform to the connection rules.

The processor may complete the operation process of the microcontroller unit in the form of a flowchart diagram by repeatedly performing steps S910 through S930.

The processor may convert the first flowchart instance and the second flowchart instance into instruction code based on the execution order of the first flowchart instance and the second flowchart instance (S940). Instruction code including an instruction, a register address, and data based on the first flowchart instance, and instruction code including an instruction, a register address, and data based on the second flowchart instance may be sequentially generated.

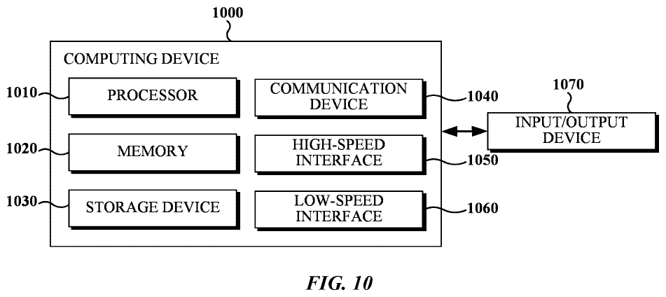

FIG. 10 illustrates an exemplary computing device 1000 for performing the above-described method and/or embodiments. According to one embodiment, the computing device 1000 may be implemented using hardware and/or software configured to interact with a user. The computing device 1000 may include, but is not limited to, a laptop computer, a desktop computer, a workstation, a personal digital assistant, a server, a blade server, and a mainframe computer. The components of the computing device 1000, their interconnections, and their functions are intended to be illustrative and are not intended to limit the implementations of the present disclosure described and/or claimed herein.

The computing device 1000 includes a processor 1010, a memory 1020, a storage device 1030, a communication device 1040, a high-speed interface 1050 connected to the memory 1020 and a high-speed expansion port, and a low-speed interface 1060 connected to a low-speed bus and a low-speed storage device. Each of the components 1010, 1020, 1030, 1040, 1050, and 1060 may be interconnected using various buses, and may be mounted on the same main board or connected in other suitable manners. The processor 1010 may be configured to process instructions of a computer program by performing basic arithmetic, logic, and input/output operations. For example, the processor 1010 may process instructions stored in the memory 1020 and the storage device 1030 and/or instructions executed within the computing device 1000, and may display graphic information on an external input/output device 1070, such as a display device coupled to the high-speed interface 1050.

The communication device 1040 may provide a configuration or function that enables the input/output device 1070 and the computing device 1000 to communicate with each other via a network, and may further provide a configuration or function that supports the input/output device 1070 and/or the computing device 1000 to communicate with another external device. For example, a request or data generated by a processor of an external device according to arbitrary program code may be transmitted to the computing device 1000 via the network under the control of the communication device 1040. Conversely, a control signal or command provided under the control of the processor 1010 of the computing device 1000 may be transmitted to the external device via the communication device 1040 and the network.

FIG. 10 illustrates that the computing device 1000 includes one processor 1010 and one memory 1020; however, the present disclosure is not limited thereto, and the computing device 1000 may be implemented using a plurality of memories, a plurality of processors, and/or a plurality of buses. In addition, although FIG. 10 illustrates a single computing device 1000, the present disclosure is not limited thereto, and a plurality of computing devices may interact with each other and perform operations necessary to execute the above-described method.

The memory 1020 may store information in the computing device 1000. According to an embodiment, the memory 1020 may include a volatile memory unit or a plurality of memory units. Additionally or alternatively, the memory 1020 may include a non-volatile memory unit or a plurality of memory units. The memory 1020 may also be implemented using other types of computer-readable media, such as a magnetic disk or an optical disk. In addition, the memory 1020 may store an operating system and at least one program code and/or instruction.

The storage device 1030 may be one or more mass storage devices for storing data for the computing device 1000. For example, the storage device 1030 may be or may be configured to include a computer-readable medium such as a magnetic disc (e.g., a hard disk or a portable disk), an optical disc, a semiconductor memory device such as an erasable programmable read-only memory (EPROM), an electrically erasable programmable read-only memory (EEPROM), or a flash memory device, and a CD-ROM or DVD-ROM disc. In addition, a computer program may be tangibly implemented on such a computer-readable medium.

The high-speed interface 1050 and the low-speed interface 1060 may serve as means for interacting with the input/output device 1070. For example, the input device may include devices such as a camera including an audio sensor and/or an image sensor, a keyboard, a microphone, and a mouse, and the output device may include devices such as a display, a speaker, and a haptic feedback device. In another example, the high-speed interface 1050 and the low-speed interface 1060 may serve as means for interfacing with a device in which the configuration or function for performing both input and output operations is integrated into a single unit, such as a touchscreen.

According to an embodiment, the high-speed interface 1050 may manage bandwidth-intensive operations for the computing device 1000, while the low-speed interface 1060 may manage operations that are less bandwidth-intensive than those managed by the high-speed interface 1050. However, this functional allocation is merely illustrative. According to an embodiment, the high-speed interface 1050 may be coupled to high-speed expansion ports capable of accommodating the memory 1020, the input/output device 1070, and various expansion cards (not shown). In addition, the low-speed interface 1060 may be coupled to the storage device 1030 and to low-speed expansion ports. Furthermore, the low-speed expansion ports, which may include various communication ports (e.g., USB, Bluetooth, Ethernet, and wireless Ethernet), may be coupled to one or more input/output devices 1070 such as a keyboard, a pointing device, or a scanner, or to networking devices such as a router or a switch through a network adapter.

The computing device 1000 may be implemented in various different forms. For example, the computing device 1000 may be implemented as a standard server or as a group of such standard servers. Additionally or alternatively, the computing device 1000 may be implemented as part of a rack server system, or as a personal computer such as a laptop. In this case, components of the computing device 1000 may be combined with other components within an arbitrary mobile device (not shown). The computing device 1000 may include one or more other computing devices, or may be configured to communicate with one or more other computing devices.

FIG. 10 illustrates that the input/output device 1070 is not included in the computing device 1000; however, this is not limiting, and the input/output device 1070 may be integrated with the computing device 1000 as a single device. In addition, although FIG. 10 illustrates the high-speed interface 1050 and/or the low-speed interface 1060 as components separate from the processor 1010, this is also not limiting, and the high-speed interface 1050 and/or the low-speed interface 1060 may be configured to be included within the processor 1010.

The above-described method and/or various embodiments may be implemented in digital electronic circuitry, computer hardware, firmware, software, and/or combinations thereof. Various embodiments of the present disclosure may be executed by a data processing device, such as one or more programmable processors and/or one or more computing devices, or implemented as a computer-readable medium and/or as a computer program stored on such a medium. The computer program may be written in any form of programming language, including a compiled or interpreted language, and may be distributed in any form, such as a stand-alone program, a module, or a subroutine. The computer program may be distributed across a single computing device, a plurality of computing devices connected via the same network, and/or a plurality of distributed computing devices connected via different networks.

The method and/or various embodiments described above may be performed by one or more processors configured to execute one or more computer programs that process, store, and/or manage arbitrary functions or operations by operating based on input data or generating output data. For example, the method and/or various embodiments of the present disclosure may be performed by a special-purpose logic circuit, such as a Field Programmable Gate Array (FPGA) or an Application Specific Integrated Circuit (ASIC). An apparatus and/or system for performing the method and/or various embodiments of the present disclosure may also be implemented as a special-purpose logic circuit, such as an FPGA or an ASIC.

The one or more processors executing the computer program may include a general-purpose or special-purpose microprocessor and/or one or more processors of an arbitrary type of digital computing device. The processor may receive instructions and/or data from each of the read-only memory and the random-access memory or may receive instructions and/or data from the read-only memory and the random-access memory. In an embodiment of the present disclosure, the components of a computing device performing the method and/or embodiments may include one or more processors for executing instructions; and one or more memories for storing instructions and/or data.

According to an embodiment, the computing device may send and receive data to and from one or more mass storage devices for storing data. For example, the computing device may receive data from a magnetic or optical disc and transmit data to the magnetic or optical disc. A computer-readable medium suitable for storing instructions and/or data related to a computer program may include any form of non-volatile memory including a semiconductor memory device such as an Erasable Programmable Read-Only Memory (EPROM), an Electrically Erasable PROM (EEPROM), and a flash memory device, without being limited thereto. For example, a computer-readable medium may include a magnetic disc such as an internal hard disc or a removable disc, a photomagnetic disk, a CD-ROM disc, and a DVD-ROM disc.

To provide interaction with a user, the computing device may include a display device (for example, a cathode ray tube (CRT) or a liquid crystal display (LCD)) for providing or displaying information to a user and a pointing device (for example, a keyboard, a mouse, or a trackball) through which the user may provide input and/or commands to the computing device by the user, without being limited thereto. In other words, the computing device may further include any other kind of device for providing interaction with the user. For example, the computing device may provide any form of sensory feedback to the user for interaction with the user, including visual feedback, auditory feedback, and/or tactile feedback. In response to the feedback, the user may provide input to the computing device through various gestures including a visual expression, voice, and motion.

In the present disclosure, various embodiments may be implemented in a computing device that includes a back-end component (for example, a data server), a middleware component (for example, an application server), and/or a front-end component. In this connection, the components may be interconnected by any form or any medium of digital data communication, such as a communication network. According to an embodiment, the communication network includes a wired network such as Ethernet, a wired home network (Power Line Communication), a telephone line communication device, and RS-serial communication; a wireless network such as a mobile communication network, a wireless LAN (WLAN), Wi-Fi, and Bluetooth; or a combination of the wired and wireless networks. For example, the communication network may include a local area network (LAN) and a wide area network (WAN).

A computing device based on the illustrative embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include a Personal Digital Assistants (PDA), a tablet PC, a game console, a wearable device, an Internet of Things (IoT) device, a virtual reality (VR) device, and an augmented reality (AR) device, but is not limited thereto. The computing device may further include other types of devices configured to interact with a user. In addition, the computing device may include a portable communication device (e.g., a mobile phone, a smartphone, or a wireless cellular phone) suitable for wireless communication over a network, such as a mobile communication network. The computing device may be configured to communicate wirelessly with a network server using wireless communication technologies and/or protocols such as Radio Frequency (RF), Microwave Frequency (MWF), and/or Infrared Ray Frequency (IRF).

Various embodiments of the present disclosure, including specific structural and functional details, are illustrative in nature. Accordingly, the embodiments of the present disclosure are not limited to those described above and may be implemented in various other forms. In addition, the terms used in the present disclosure are intended for describing some embodiments and should not be construed as limiting the embodiments. For example, singular words and the descriptions above may be construed to include plural forms unless the context dictates otherwise.

Unless defined otherwise, terms used in the present disclosure, including technical or scientific terms, may convey the same meaning understood generally by those skilled in the art to which the present disclosure belongs. Among the terms used in the present disclosure, commonly used terms, such as those defined in ordinary dictionaries, should be interpreted to convey the same meaning in the context of related technology.

The present disclosure has been described with reference to particular embodiments; however, various modifications and changes may be made without departing from the technical scope of the present disclosure that may be understood by those skilled in the art to which the present disclosure belongs. In addition, it should be understood that the modifications and changes fall within the technical scope of the appended claims.

[Detailed Description of Main Elements]

| | |
|---|---|
| 410: screen window processor | 411: design window processor |
| 412: setting window processor | 420: operation process designer |
| 421: flowchart instance manager | 422: flowchart instance error |
| | detector |
| 430: instruction code generator | 431: instruction derivation unit |
| 432: instruction input format | 440: data storage |
| derivation unit | |
| 441: flowchart component storage | 442: operation process storage |
| 443: code conversion logic storage | 510: design window |
| 520: component window | 530: setting window |

What is claimed is:

1. A system for generating instruction codes of a microcontroller unit, the system comprising:
a memory configured to store at least one instruction;
a component storage configured to store information on at least one flowchart component;
a code conversion logic storage configured to store code conversion logic for generating instruction codes based on at least one flowchart instance; and
at least one processor configured to execute the at least one instruction stored in the memory,
wherein the at least one instruction comprises instructions for:
generating a first flowchart instance based on the at least one flowchart component;
receiving at least one of a target component, a property, and a value of the first flowchart instance to generate an operation process; and
converting the operation process into an instruction code based on the code conversion logic, the instruction code including at least one assembly instruction, a register address, and data.

2. The system for generating instruction codes of a microcontroller unit of claim 1,
wherein the at least one instruction comprises instructions for:
generating a second flowchart instance based on the at least one flowchart component;
receiving at least one of a target component, a property, and a value of the second flowchart instance; and
setting an execution order between the first flowchart instance and the second flowchart instance.

3. The system for generating instruction codes of a microcontroller unit of claim 1,
wherein the flowchart component comprises at least one of:
a write (WRITE) component for writing a specific value to a specific register field;
an input wait (READWAIT) component for waiting for a specific value to be input to a specific register field;
a wait (WAIT) component for waiting for a predetermined period of time;
a condition (IF) component for branching according to a condition;
a move (GOTO) component for moving to a specific location;
a call (CALL) component for moving to a specific location and allowing a return;
a label (LABEL) component for designating a branch target;
a label reference (LABEL_REF) component for referring to a label;
a start (START) component for indicating a beginning; and
an end (END) component for indicating an end.

4. The system for generating instruction codes of a microcontroller unit of claim 3,
wherein the flowchart component comprises a border having a distinctive shape.

5. The system for generating instruction codes of a microcontroller unit of claim 4,
wherein:
the label component and the label reference component enable two or more flowchart components, which are spaced apart from each other, to be substantially connected; and
at least one of a label name and a color is set for the label component and the label reference component to enable identification.

6. The system for generating instruction codes of a microcontroller unit of claim 2,
wherein the at least one instruction comprises instructions for:
determining whether at least one of a target component, a property, and a value of the first flowchart instance, and at least one of a target component, a property, and a value of the second flowchart instance conform to an input rule; and
detecting an error.

7. The system for generating instruction codes of a microcontroller unit of claim 3,
wherein at least one of the flowchart components is matched with at least two assembly instructions,
and the at least one instruction comprises instructions for determining one assembly instruction based on at least one of a target component, a property, and a value of the first flowchart instance.

8. The system for generating instruction codes of a microcontroller unit of claim 7,
wherein the at least one instruction comprises instructions for determining a register address and data of the determined assembly instruction based on at least one of a target component, a property, and a value of the first flowchart instance.

9. The system for generating instruction codes of a microcontroller unit of claim 1,
wherein the target component comprises at least one of a reset component, an isolation component, a switch control component; a retention component, an automatic power manager component, a reference clock gating component, a memory component, a handshake component, a clock link component, a P-channel handshake component, a user-defined output component, and a user-defined input component.

10. The system for generating instruction codes of a microcontroller unit of claim 1,
wherein the target component comprises at least one of an information register generation component, a timeout register generation component, an upper-level information transfer register generation component, an internal register storage component, an internal register control interrupt generation component, an external input control interrupt generation component, a timer generation component, and a domain power manager connection component.

11. A method for generating instruction codes of a microcontroller unit,
the method being performed by at least one processor in a computer system including a component storage configured to store information on at least one flowchart component and a code conversion logic storage configured to store code conversion logic for generating instruction codes based on at least one flowchart instance,
the method comprising:
generating a first flowchart instance based on the at least one flowchart component;
receiving at least one of a target component, a property, and a value of the first flowchart instance to generate an operation process; and
converting the operation process into an instruction code based on the code conversion logic, the instruction code including an assembly instruction, a register address, and data.

12. The method for generating instruction codes of a microcontroller unit of claim 11, further comprising:
generating a second flowchart instance based on the at least one flowchart component;
receiving at least one of a target component, a property, and a value of the second flowchart instance; and
setting an execution order between the first flowchart instance and the second flowchart instance.

13. The method for generating instruction codes of a microcontroller unit of claim 11,
wherein the flowchart component comprises at least one of:
a write (WRITE) component for writing a specific value to a specific register field;
an input wait (READWAIT) component for waiting for a specific value to be input to a specific register field;
a wait (WAIT) component for waiting for a predetermined period of time;
a condition (IF) component for branching according to a condition;
a move (GOTO) component for moving to a specific location;
a call (CALL) component for moving to a specific location and allowing a return;
a label (LABEL) component;
a label reference (LABEL_REF) component;
a start (START) component; and
an end (END) component.

14. The method for generating instruction codes of a microcontroller unit of claim 13,
wherein the flowchart component comprises a border having a distinctive shape.

15. The method for generating instruction codes of a microcontroller unit of claim 14,
wherein:
the label component and the label reference component enable two or more flowchart components, which are spaced apart from each other, to be substantially connected; and
at least one of a label name and a color is set for the label component and the label reference component to enable identification.

16. The method for generating instruction codes of a microcontroller unit of claim 12, further comprising:
determining whether at least one of a target component, a property, and a value of the first flowchart instance, and at least one of a target component, a property, and a value of the second flowchart instance conform to an input rule; and
detecting an error.

17. The method for generating instruction codes of a microcontroller unit of claim 13, further comprising:
matching at least one of the flowchart components with at least two assembly instructions; and
determining one assembly instruction based on at least one of a target component, a property, and a value of the first flowchart instance.

18. The method for generating instruction codes of a microcontroller unit of claim 17,
further comprising determining a register address and data of the determined assembly instruction based on a target component, a property, and a value of the first flowchart instance.

19. The method for generating instruction codes of a microcontroller unit of claim 11,
wherein the target component comprises at least one of a reset component, an isolation component, a switch control component, a retention component, an automatic power manager component, a reference clock gating component, a memory component, a handshake component, a clock link component, a P-channel handshake component, a user-defined output component, and a user-defined input component.

20. The method for generating instruction codes of a microcontroller unit of claim 11,
wherein the target component comprises at least one of an information register generation component, a timeout register generation component, an upper-level information transfer register generation component, an internal register storage component, an internal register control interrupt generation component, an external input control interrupt generation component, a timer generation component, and a domain power manager connection component.
